(19) United States
(12) Patent Application Publication
(10) Pub. No.: US 2025/0128933 A1
(43) Pub. Date: Apr. 24, 2025

(54) Sliding Martingale

(71) Applicant: Jean Philippe Giacomini, Harrodsburg, KY (US)

(72) Inventor: Jean Philippe Giacomini, Harrodsburg, KY (US)

(21) Appl. No.: 18/922,990

(22) Filed: Oct. 22, 2024

Related U.S. Application Data
(60) Provisional application No. 63/545,188, filed on Oct. 22, 2023.

(51) Int. Cl. B68B 1/04

(52) U.S. Cl. CPC B68B 1/04

(57) ABSTRACT

The present invention is a modified sliding martingale. Instead of the rein-rings (common to all, except the Standing Martingale, or “Tie Down” that is attached to a noseband and not the reins), the rein-rings of the sliding martingale of the present invention are sliding on a continuous loop perpendicular to the horse cervical spine (his neck). The loop is attached in front of the chest to a standard martingale chest strap and a leather loop around the neck, both of them adjustable to the horse's size and conformation.

### CROSS REFERENCE TO RELATED APPLICATIONS

This application claims priority to U.S. provisional application Ser. No. 63/545,188 filed on Oct. 22, 2023, and fully incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates to a modified martingale, which is a piece of horse-riding equipment that helps the rider control the horse's head.

### Description of the Related Art

Martingales are a piece of horse-riding equipment (or “tack”) that helps riders control a horse's head by applying (generally) downward pressure on the horse's mouth. They consist of two vertical straps with “pass-through” rein rings (“rein rings”) adjusted to the point the rider wishes to stop the undesirable head-raising horse behavior. They have been in use for several centuries and use rein-rings attached to straps to create leverage that limits the horse tendency to resists upwards, without any progressive or multi-directional corrective action. When adjusted too long, they have no educational value. Riders usually prefer to limit their potentially negative effects: the horse is surprised when he hits the contact and often overreacts to the sudden pain. The Running Martingale, the Bib Martingale in all is iterations, the “German Martingale” (also known as the Olympic Martingale, the Market Harborough in England or the Howlett in France, The Abott Davies Balancing Rein), all offer no action until the horse lifts his head and hits the end of the 2 straps' length that attaches the rein-ring to the chest strap fixed to the middle of the girth between the horse's front legs.

RUNNING MARTINGALE: What it is: A running martingale is made of two straps, a neck strap and a chest strap, that are attached to the horse's girth and pass between its front legs. The straps divide into two pieces, with small metal rings at the ends where the reins pass through. How it works: Before the horse raising his head, the martingale has no action. When the horse raises its head, the martingale adds downward leverage through the reins to encourage the horse to lower its head . . . Or resists violently. When to use it: Running martingales are used in eventing and horse racing, and can also be used in saddle seat and western riding.

BIB MARTINGALE: A bib martingale is a piece of horse tack that helps control a horse's head and reins. What it is: A bib martingale is a type of running martingale that has a bib made of leather that connect the neck straps and fixes them at a constant distance left-right, it is much more constraining than a standard running martingale because of added limitations to movement. What it does: A bib martingale helps keep the reins together and prevents the horse from biting the neck straps or raising its head too high. How it's used: A bib martingale can be used as a training aid for horses, especially young horses, and to help with tight turns. How it works: A bib martingale works by applying downward pressure on the reins when the horse raises its head. This encourages the horse to lower its head.

IRISH MARTINGALE Used in racing or with young horses, it simply limits the distanced between left and right rein position. It has no downward effect, only laterally and prevents a jumping horse from ending with the reins over his head after landing from a high jump. STANDING MARTINGALE: A standing martingale is a piece of horse tack that limits how high a horse can raise its head. It acts directly on the nose and not on the mouth. In polo and roping, it is considered a safety item (preventing the horse from being hit by the polo mallet or the roping lariat (rope). In Show Hunters competition, it is a traditional, aesthetic piece of equipment that is never adjusted as to have any real effect. It is also known as a “TIEDOWN” when used by cowboys: a single strap attached to a strong noseband. The function is the same as the Standing Martingale, Just a different name due to culture (“western” versus “English”). Purpose: A standing martingale prevents a horse from tossing its head or raising it too high. It also helps keep the horse's head carriage better. How it works: A standing martingale is made of leather and has a neck strap that connects to the girth and the noseband. It passes between the horse's front legs.

GERMAN MARTINGALE What it is: A German martingale (“Olympic M.”, “Market Harborough” in England, “Howlett” in France, “Abbott Davies Balancing Rein) is a piece of tack that consists of a split fork that runs from the horse's chest through the bit's rings and attaches to the reins. There are several rings on the reins as a way to adjust the length of the restraint. It functions like a running martingale in its effect, but with a more progressive leverage. It has a much better educational value for that reason. Its effect becomes obsolete when the horse yields. How it works: The martingale helps horses learn to flex at the poll and give to the bit. It works by drawing the horse into a more favorable position, with a flexed poll. When used properly, the bit releases as the horse gives in, rewarding the horse for holding its head in the right position. TRAINING MARTINGALE: A training martingale is a piece of horse riding equipment that helps teach a horse to carry its head in a lower, more balanced position. How it works: A training martingale is a Y-shaped device with rings on each side that the reins run through. When a horse lifts its head too high, the martingale applies pressure to the bit, It keeps the reins close to the neck. It is mostly used in breed shows (Arabians) to create a steady frame.

### SUMMARY OF THE INVENTION

The present invention is a modified sliding martingale. Instead of the rein-rings (common to all, except the Standing Martingale, or “Tie Down” that is attached to a noseband and not the reins), the rein-rings of the sliding martingale of the present invention are sliding on a continuous loop perpendicular to the horse cervical spine (his neck). The loop is attached in front of the chest to a standard martingale chest strap and a leather loop around the neck, both of them adjustable to the horse's size and conformation.

### BRIEF DESCRIPTION OF THE DRAWINGS

FIG. 1 is a front view of the sliding martingale.

FIG. 2 is a front view of the sliding martingale on a horse.

FIG. 3 is a side view of the sliding martingale on a horse.

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

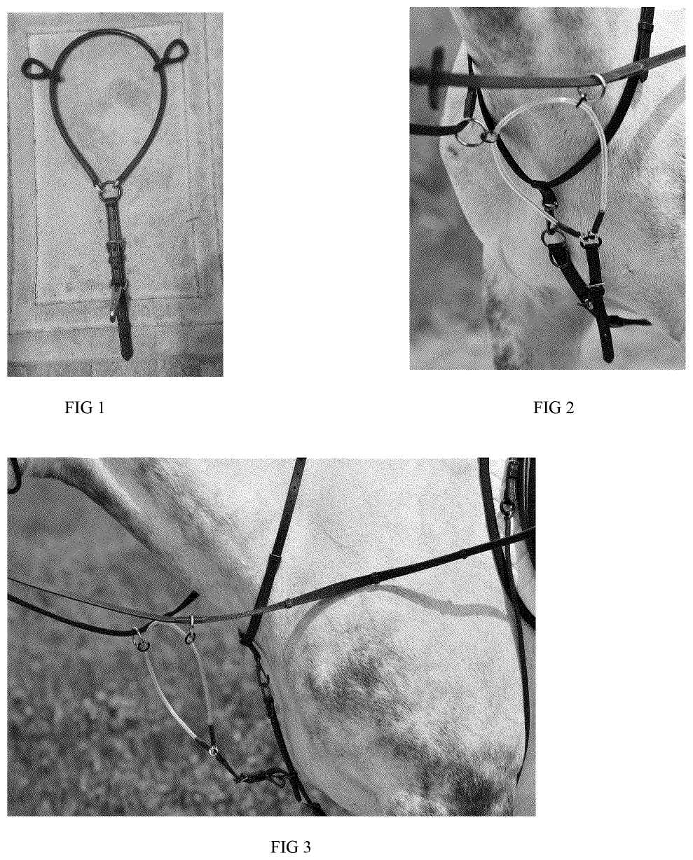

FIG. 1 is a front view of the sliding martingale. FIG. 2 is a front view of the sliding martingale on a horse. FIG. 3 is a side view of the sliding martingale on a horse. As can be seen in FIG. 1, the sliding martingale consists of a large inner loop, two smaller sliding loops, and a straight attachment tether. Instead of the rein-rings (common to all, except the Standing Martingale, or “Tie Down” that is attached to a noseband and not the reins), the rein-rings of the sliding martingale of the present invention are sliding on a continuous loop perpendicular to the horse cervical spine (his neck). The loop is attached in front of the chest to a standard martingale chest strap and a leather loop around the neck, both of them adjustable to the horse's size and conformation. The present sliding martingale is made of different materials with more or less “give” ranging from a 5% stretch to a 50% stretch. The sliding configuration allows it to change its configuration according to the horse's head position and the rider's actions: if the horse raises his head, the loop becomes progressively narrower, tighten the side of the bit in the horse's mouth and progressively (quickly) convinces him to return to a lower position that becomes progressively more comfortable. If the horse raises one side of his head, the rein-ring follows and resists it progressively, while bringing it back to level, also progressively. The pressure increases in very small increments, and the relief also increases in equally small increments.

When the riders turns the horse by moving one hand to the side, the loop turns into a wider triangle that lowers both rein-rings and entices the horse to turn in a lower (classically desirable) head position. If the horse completely inverts the shape of his neck (from convex to concave), which has a profound negative effect on his entire musculature (for instance before or after jumping an obstacle), the sliding martingale will bring him back painlessly to a convex (desirable) shape. The effect is so pervasive that its effect becomes obsolete quire rapidly. It is an educational tool that provides soft, effective control. Experiments have been made with amateur riding on a “horse simulator” equipped with many sensors reflecting the undesirable actions of the rider's hands through a on-time screen (excessive left-right, up-down hand movements). The hand actions were corrected under 15 minutes, and the session proved educational, as riders were performing immediately better that they had without the sliding martingale.

Serpentines and FIG. 8s are foundational exercises for all horses, from racing to reining, dressage, showjumping, or endurance. The included turns create symmetry of movement, a regular rhythm, roundness and relaxation of the topline with a supple neck and long-term soundness. It develops the accuracy of the performance. Turns flex the back laterally and encourage the horse to lengthen his entire body on the outside of the turn. It arches the neck and opens the throat latch in a forward and downward direction, as a foundation of all classical training principles. When asking for a *really* small turn (10 feet diameter, as a horse would do when turning around in a small stall), use a shortened opening rein on the inside, while releasing the outside rein, the rider's weight squarely loading the outside stirrup. It is fundamental for the inside hand to move away from the neck inside the turn and never pull back toward the shoulder. This would block it, reduce its range of motion, stiffen the neck, compromise the rhythm and the impulsion and this is how we see many horses plainly refusing to turn. Start the process at the walk, then continue in trot and canter and progressively increase speed. The more frequent the turns, the easier to obtain the correct response to increasingly lighter turning aids, suppleness and relaxation. Because the smallest turns technique asks for the maximum bending of the horse's back, the wider turns become automatically more symmetrical—and much easier!

When the rider uses an opening rein to turn (inside hand away from the neck, like opening a book), the sliding martingale loop geometry becomes wider and lowers the contact on the inside of the turn. The outside rein follows softly without being shortened and the contact remains on both reins. Through its progressive “sliding” action, the horse is quickly persuaded to turn, bend, and lower his head at the same time without resistance. This exercise decompresses the thoracic vertebrae and stretches all the muscles on the outside of the body.

By improving the lateral balance and the uprightness, the sliding martingale of the present invention relaxes and slows down anxious horses. More balance=less fear of falling=less anxiety=less likelihood of bucking. Shorter turns with a pronounced bend are the most effective way: a. To loosen the neck and tilt the withers slightly to the outside, which is key to lateral flexion and uprightness for balance. It is greatly facilitated by loading the outside stirrup and releasing the outside rein. b. To round the topline without compression back to front (or front to back). This type of turns followed by a neck stretch to the ground were one of Master Oliveira favorite exercises. c. To free the shoulders and increase their lateral range of motion, the outside one has to reach forward and inward to cover the extra ground on the outside of the turn or circle. d. To engage and flex the inside hind leg and increase the drive of the outside hind leg.

I claim:

1. A sliding martingale for controlling the movement of a horse, said martingale consisting of:
a large center loop;
two small sliding loops attached to the large center loop;
an attachment tether attached at the bottom of the large loop;
wherein the sliding martingale is attached to the standard tack of a horse to improve control of the horse.
